(19) United States
(12) Patent Application Publication
(10) Pub. No.: US 2025/0190586 A1
(43) Pub. Date: Jun. 12, 2025

(54) ANALYSIS SUPPORT SYSTEM, ANALYSIS SUPPORT METHOD, AND RECORDING MEDIUM

(71) Applicant: Panasonic Automotive Systems Co., Ltd., Kanagawa (JP)

(72) Inventors: Yuishi TORISAKI, Osaka (JP); Shoichiro SEKIYA, Osaka (JP); Takayoshi ITO, Osaka (JP); Kinya OTANI, Kanagawa (JP)

(73) Assignee: Panasonic Automotive Systems Co., Ltd., Kanagawa (JP)

(21) Appl. No.: 18/970,208

(22) Filed: Dec. 5, 2024

(30) Foreign Application Priority Data
Dec. 12, 2023 (JP) 2023-209681

(51) Int. Cl. G06F 21/57

(52) U.S. Cl. CPC G06F 21/577; G06F 2221/033

(57) ABSTRACT

An analysis support system supports analysis for addressing vulnerability of software provided to vehicles. The analysis support system includes: a data receiver that obtains vehicle type information on each of a plurality of vehicle types of the vehicles provided with the software having vulnerability; and a determiner that performs a first determination to classify the plurality of vehicle types into two or more groups for the analysis, based on the vehicle type information obtained for each of the plurality of vehicle types.

### CROSS REFERENCE TO RELATED APPLICATION

The present application is based on and claims priority of Japanese Patent Application No. 2023-209681 filed on Dec. 12, 2023.

### BACKGROUND

### 1. Technical Field

The present disclosure relates to an analysis support system, an analysis support method, and a recording medium.

### 2. Description of the Related Art

Techniques for analyzing a risk in a device reported to have vulnerability in software provided to the device are known. For example, International Patent Publication No. WO 2019/163972 (PTL 1) discloses a threat analysis system and an analysis method that enable threat analysis more suitable for security requirements of a system to be realized.

### SUMMARY

However, the analysis support system and the like can be improved upon.

In consideration thereof, the present disclosure provides an analysis support system, an analysis support method, and a recording medium capable of improving upon the above related art.

In accordance with an aspect of the present disclosure, an analysis support system that supports analysis for addressing vulnerability of software provided to vehicles includes: an obtainer that obtains vehicle type information on each of a plurality of vehicle types of the vehicles provided with the software having vulnerability; and a determiner that performs a first determination to classify the plurality of vehicle types into two or more groups for the analysis, based on the vehicle type information obtained for each of the plurality of vehicle types.

In accordance with another aspect of the present disclosure, an analysis support method of supporting analysis for addressing vulnerability of software provided to vehicles includes: obtaining vehicle type information on each of a plurality of vehicle types of the vehicles provided with the software having vulnerability; and performing a first determination to classify the plurality of vehicle types into two or more groups for the analysis, based on the vehicle type information obtained for each of the plurality of vehicle types.

In accordance with still another aspect of the present disclosure, a non-transitory computer-readable recording medium for use in a computer has recorded thereon a computer program for causing the computer to perform the above-described analysis support method.

According to an aspect of the present disclosure, an analysis support system and the like capable of improving upon can be realized.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a diagram illustrating a configuration of an analysis support system according to an embodiment.

FIG. 2 is a diagram for describing information obtained by a vulnerability management system according to the embodiment.

FIG. 3 is a diagram for describing a concept of grouping according to the embodiment.

FIG. 4 is a diagram for describing information outputted from the vulnerability management system according to the embodiment.

FIG. 5 is a diagram illustrating an example of group information according to the embodiment.

FIG. 6A is a diagram illustrating an example of ECU vehicle type common information according to the embodiment.

FIG. 6B is a diagram illustrating an example of ECU vehicle type unique information according to the embodiment.

FIG. 6C is a diagram illustrating an example of vehicle type information according to the embodiment.

FIG. 7 is a sequence diagram illustrating an operation of the analysis support system according to the embodiment.

FIG. 8 is a diagram illustrating a vulnerability analysis result before grouping according to the embodiment.

FIG. 9 is a diagram illustrating a vulnerability analysis result after grouping according to the embodiment.

FIG. 10 is a flow chart illustrating a first example of a detailed operation of step S17 illustrated in FIG. 7.

FIG. 11 is a flow chart illustrating a second example of a detailed operation of step S17 illustrated in FIG. 7.

FIG. 12 is a flow chart illustrating a third example of a detailed operation of step S17 illustrated in FIG. 7.

FIG. 13 is a flow chart illustrating a fourth example of a detailed operation of step S17 illustrated in FIG. 7.

FIG. 14 is a flow chart illustrating a fifth example of a detailed operation of step S17 illustrated in FIG. 7.

FIG. 15 is a flow chart illustrating an operation of determining a subgroup after a determination of a group according to the embodiment.

FIG. 16 is a flow chart illustrating an operation of examining a countermeasure according to the embodiment.

FIG. 17 is a diagram illustrating a vulnerability analysis result after registration of a countermeasure according to the embodiment.

### DETAILED DESCRIPTION OF THE EMBODIMENTS

### (Circumstances Leading to the Present Disclosure)

Prior to a description of an embodiment of the present disclosure, circumstances leading to the present disclosure will be described.

With an increase in scale of software, an increase in a ratio of OSS (Open Source Software), and the like in vehicles, there is a need to continuously monitor whether new vulnerabilities in software have been discovered even after shipment of each vehicle and, when such vulnerabilities are present, the vulnerabilities must be addressed in view of a risk. To this end, various studies for performing analysis for addressing vulnerability are being carried out as described in, for example, PTL 1.

When a new vulnerability is discovered, with respect to a vehicle type (target vehicle type) mounted with a target ECU (Electronic Control Unit) that is an ECU including the vulnerability, a risk must be checked and addressed per vehicle type. A large number of vehicle types mounted with the target ECU is expected due to derivative models of the vehicle type or a lateral deployment of ECUs. In other words, it is expected that a plurality of ECUs and a plurality of vehicles must be checked with respect to one piece of vulnerable software. In addition, even with the same software, since effective functions, arrangements, peripheral devices, and the like differ depending on a vehicle type to which the software is provided, an ECU to which the software is provided, and the like, examination targets to be addressed are expected to be wide-ranging and varied. Since performing a detailed consequences analysis and an examination of an addressing method (in other words, performing an analysis for addressing a vulnerability) with respect to each target vehicle type is costly, an improvement in efficiency is required. The addressing method is to be determined by, for example, an analyst.

However, PTL 1 described above does not disclose a technique for improving efficiency of such analysis for addressing vulnerability. In other words, the technique according to PTL 1 can be improved upon performing an analysis for addressing vulnerability in an efficient manner,

In consideration thereof, the inventors of the present application conducted extensive research on supporting efficient performance of analysis for addressing vulnerability and invented the analysis support system and the like to be described hereinafter. For example, focusing on the fact that a derivative source vehicle type and a derivative vehicle type often have similar configurations, the inventors of the present application invented the analysis support system and the like which are capable of solving a problem in that efficiency of analysis declines due to overlapping examination contents between the derivative source vehicle type and the derivative vehicle type.

In accordance with a first aspect of the present disclosure, an analysis support system that supports s analysis for addressing vulnerability of software provided to vehicles includes: an obtainer that obtains vehicle type information on each of a plurality of vehicle types of the vehicles provided with the software having vulnerability; and a determiner that performs a first determination to classify the plurality of vehicle types into two or more groups for the analysis, based on the vehicle type information obtained for each of the plurality of vehicle types.

Accordingly, based on the vehicle type information, one or more vehicle types which may have same countermeasure contents can be classified into the same group. In other words, an analyst needs to perform analysis only for each of two or more groups of the vehicle types. Therefore, it is possible to reduce a time required for the analysis, in comparison to a case where each of the vehicle types is individually analyzed. As a result, the analysis support system is capable of supporting efficient performance of analysis by the analyst for addressing vulnerability.

For example, in accordance with a second aspect, it is possible in the analysis support system in accordance with the first aspect that the vehicle type information includes information indicating a vehicle configuration of a corresponding one of the plurality of vehicle types, and that the determiner performs the first determination based on a level of matching of the vehicle configuration between the plurality of vehicle types.

Accordingly, vehicle types with similar vehicle configurations can be allocated into the same group. Since vehicle types with similar vehicle configurations are considered to have the same countermeasure contents, a time required for analysis of the vehicle types with similar vehicle configurations can be reduced.

For example, in accordance with a third aspect, it is possible in the analysis support system in accordance with the second aspect that the information indicating the vehicle configuration includes information on one or more devices disposed on an attack path predicted based on the vulnerability, and that the determiner performs the first determination based on a level of matching of the one or more devices between the plurality of vehicle types.

Accordingly, the vehicle types provided with one or more similar devices that are disposed on an attack path can be allocated into the same group. Since vehicle types provided with one or more similar devices that are disposed on an attack path are considered to have the same countermeasure contents, a time required for analysis of the vehicle types provided with one or more similar devices that are disposed on an attack path can be reduced.

For example, in accordance with a fourth aspect, it is possible in the analysis support system in accordance with the third aspect that the information indicating the vehicle configuration includes information on one or more predetermined points disposed on the attack path predicted based on the vulnerability, and that the determiner performs the first determination based on a level of matching of the one or more predetermined points between the plurality of vehicle types.

Accordingly, vehicle types with similar predetermined points on the attack path can be allocated to the same group. Since vehicle types with similar predetermined points on the attack path are considered to have the same countermeasure contents, a time required for analysis of the vehicle types with similar predetermined points on the attack path can be reduced.

For example, in accordance with a fifth aspect, it is possible in the analysis support system in accordance with the fourth aspect that the one or more the predetermined points include at least one of an entry point, a device including a security countermeasure function, or a target asset to be attacked.

Accordingly, a time required for analysis of the vehicle types for which at least one of an entry point, a device including a security countermeasure function, and a target asset to be attacked is similar can be reduced.

For example, in accordance with a sixth aspect, it is possible in the analysis support system in accordance with any one of the second to fifth aspects that the vehicle type information includes information indicating whether or not a corresponding one of the plurality of vehicle types is a derivative vehicle type, and that the determiner performs the first determination based on whether or not each of the plurality of vehicle types is a derivative vehicle type.

Accordingly, for example, a derivative vehicle type and a derivative source vehicle type can be allocated to the same group. Since the derivative vehicle type and the derivative source vehicle type are considered to have the same countermeasure contents, a time required for analysis of the derivative vehicle type can be reduced.

For example, in accordance with a seventh aspect, it is possible in the analysis support system in accordance with any one of the second to sixth aspects that a device provided with the software having vulnerability includes a plurality of functions, and that the determiner performs the first determination based on a similarity of an available or unavailable setting for each of the plurality of functions of the device between the plurality of vehicle types.

Accordingly, vehicle types with similar available and unavailable settings for functions of a device can be allocated to the same group. Since vehicle types with similar available and unavailable settings for the functions of a device are considered to have the same countermeasure contents, a time required for analysis of the vehicle types with similar available and unavailable settings for the functions of a device can be reduced.

For example, in accordance with an eighth aspect, it is possible in the analysis support system in accordance with any one of the first to seventh aspects that a plurality of determination conditions are set for the first determination, that the obtainer obtains a first vulnerability analysis result of analyzing vulnerability of each of the plurality of vehicle types provided with the software having vulnerability, and that the determiner performs the first determination under a determination condition or a combination of two or more determination conditions identified from the plurality of determination conditions based on at least one of the vehicle type information or the first vulnerability analysis result.

Accordingly, since vehicle types can be classified using a determination condition in accordance with at least one of vehicle type information and a first vulnerability analysis result, a plurality of vehicle types can be classified into more appropriate groups.

For example, in accordance with a ninth aspect, it is possible in the analysis support system in accordance with any one of the first to eighth aspects that the obtainer further obtains, for each of the plurality of vehicle types, information indicating an Over The Air (OTA) compatibility state of at least one of the vehicle type or a device provided with the software having vulnerability, and that the determiner performs a second determination for classifying two or more vehicle types classified in each of the two or more groups into two or more sub-groups, based on the information indicating the OTA compatibility state.

Accordingly, the analyst may determine countermeasure contents for each subgroup with possibly different countermeasure contents. Therefore, the analysis support system can support a determination by the analyst of countermeasure contents depending on an OTA compatibility state.

For example, in accordance with a tenth aspect, it is possible in the analysis support system in accordance with the ninth aspect that the determiner determines, for each of the plurality of vehicle types, whether or not the vehicle type is compatible with OTA, based on the information indicating the OTA compatibility state, and that when the vehicle type is determined to be compatible with OTA, the determiner further determines whether or not the device provided with the software having vulnerability is compatible with OTA.

Accordingly, a plurality of vehicle types can be classified into at least two or more subgroups based on a result of determining whether or not each of the vehicle types is compatible with OTA and a result of determining whether or not the device in the vehicle type is compatible with OTA.

For example, in accordance with an eleventh aspect, it is possible in the analysis support system in accordance with any one of the first to eighth aspects that the obtainer obtains, for each of the two or more groups classified, a second vulnerability analysis result regarding each of one or more vehicle types classified into the group, under assumption that a countermeasure for vulnerability of the software provided to the vehicle type has been performed, and that the determiner excludes, from the group, a vehicle type for which a risk under the assumption is not lower than the risk before the countermeasure is performed.

Accordingly, a vehicle type considered to have been erroneously classified to a group can be excluded from the group. Therefore, the group becomes more accurate. This enables the analyst to determine more appropriate countermeasure contents.

For example, in accordance with a twelfth aspect, it is possible that the analysis support system in accordance with any one of the first to eleventh aspects further includes a notifier that performs notification of completion of the first determination performed by the determiner.

Accordingly, the analyst can be notified of a completion of processing of the first determination. Performing such a notification enables the analyst to reduce time loss and smoothly determine countermeasure contents.

For example, in accordance with a thirteenth aspect, it is possible that the analysis support system in accordance with any one of the first to eighth aspects further includes: a display outputter that causes a display device to display a determination result of the determiner.

Accordingly, the analyst can use a determination result as reference when determining countermeasure contents. Therefore, the analysis support system is capable of further supporting efficient performance of analysis by the analyst for addressing vulnerability.

In accordance with another aspect of the present disclosure, an analysis support method of supporting analysis for addressing vulnerability of software provided to vehicles includes: obtaining vehicle type information on each of a plurality of vehicle types of the vehicles provided with the software having vulnerability; and performing a first determination to classify the plurality of vehicle types into two or more groups for the analysis, based on the vehicle type information obtained for each of the plurality of vehicle types. Furthermore, in accordance with still another aspect of the present disclosure, a non-transitory computer-readable recording medium for use in a computer has recorded thereon a computer program for causing the computer to perform the above-described analysis support method.

Accordingly, similar advantageous effects to the analysis support system described above are produced.

General or specific aspects of the present disclosure may be implemented to a system, a device, a method, an integrated circuit, a computer program, a non-transitory computer-readable recording medium such as a Compact Disc-Read Only Memory (CD-ROM), or any given combination thereof.

Hereinafter, certain exemplary embodiments will be described in detail with reference to the accompanying Drawings.

The following embodiments are general or specific examples of the present disclosure. The numerical values, shapes, materials, elements, arrangement and connection configuration of the elements, steps, the order of the steps, etc., described in the following embodiments are merely examples, and are not intended to limit the present disclosure. Among elements in the following embodiments, those not described in any one of the independent claims indicating the broadest concept of the present disclosure are described as optional elements.

Additionally, components that are essentially the same share like reference signs in the figures. Accordingly, overlapping explanations thereof are omitted or simplified.

It should also be noted that the following description may include numerical values and numerical value ranges. However, such numerical values and numerical value ranges do not mean exact meanings only. They also mean the substantially same ranges including a difference of, for example, about several % (or about 10%) from the completely same range.

### Embodiment

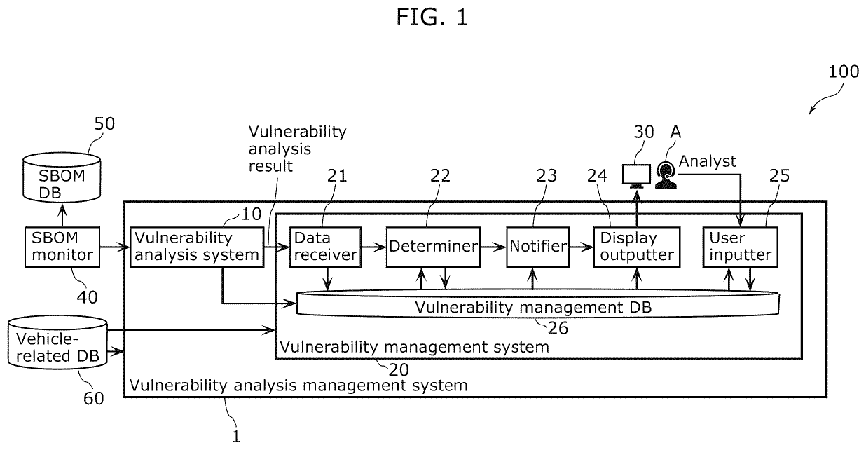

Hereinafter, an analysis support system according to the present embodiment will be described with reference to FIGS. 1 to 17.

### [1. Configuration of Analysis Support System]

First, a configuration of the analysis support system according to the present embodiment will be described with reference to FIGS. 1 to 6C. FIG. 1 is a diagram illustrating a configuration of analysis support system 100 according to the present embodiment. Analysis support system 100 is a system that supports analysis for addressing vulnerability of software provided to vehicles.

As illustrated in FIG. 1, analysis support system 100 includes vulnerability analysis management system 1, display apparatus 30, SBOM (Software Bill of Materials: a table of software components) monitor 40, SBOM DB 50, and vehicle-related DB 60. Vulnerability analysis management system 1 is a system that is used, when a new vulnerability of software is discovered, in order to efficiently perform analysis for addressing the vulnerability. Vulnerability analysis management system 1 includes vulnerability analysis system 10 and vulnerability management system 20.

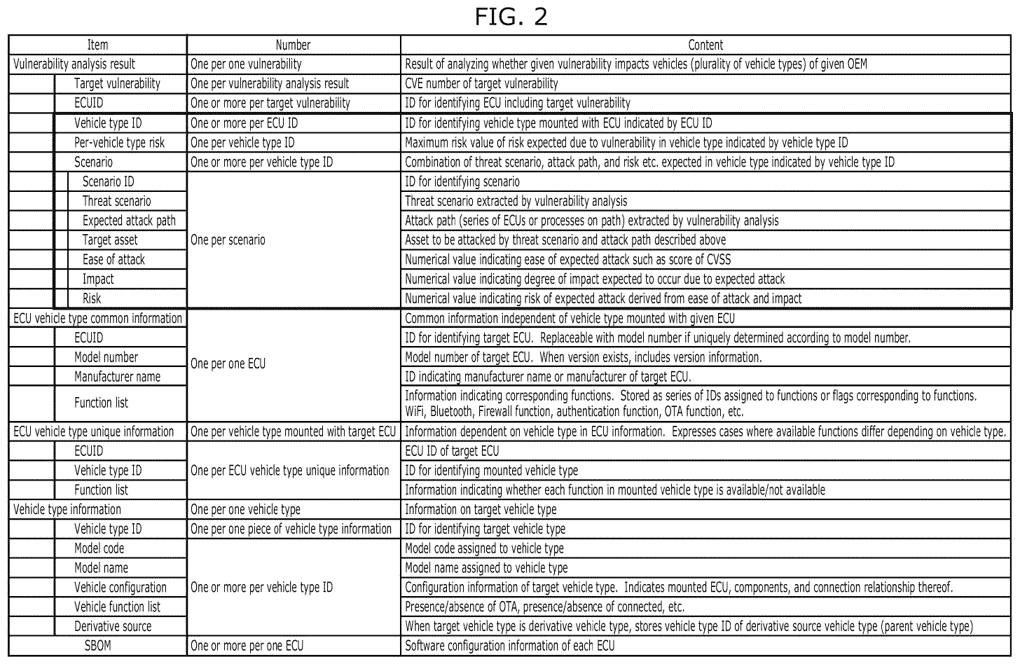

Vulnerability analysis system 10 is a system that performs vulnerability analysis with respect to each device including the discovered vulnerability, and performs risk analysis based on impact and ease of attack. Vulnerability analysis system 10 outputs a vulnerability analysis result that is a result of performing the risk analysis to vulnerability management system 20. FIG. 2 is a diagram for describing information obtained by vulnerability management system 20 according to the present embodiment.

As illustrated in FIG. 2, a vulnerability analysis result is a result of analyzing, with respect to a given vulnerability, whether or not the vulnerability has an impact on vehicles (a plurality of vehicle types) of a given OEM. The vulnerability analysis result includes a target vulnerability, an ECU ID, a vehicle type ID, a per-vehicle type risk, and a scenario as items. The vehicle type ID is an ID for identifying a vehicle type mounted with an ECU identified by an ECU ID. The ECU ID indicates an ECU including a target vulnerability to be analyzed. When there are a plurality of vehicle types each mounted with the ECU, the vulnerability analysis result includes a plurality of vehicle type IDs. In addition, the scenario includes a scenario ID, a threat scenario, an expected attack path, a target asset (a target asset to be attacked), an ease of attack, an impact, and a risk. Any known technique may be used in analysis of each item of the scenario by vulnerability analysis system 10. Each item of the scenario can be identified based on, for example, vehicle configuration information and vulnerability of software.

Note that information inside a bold frame illustrated in FIG. 2 may also be described as per-vehicle type analysis information. In addition, although details will be described later, ECU vehicle type common information, ECU vehicle type unique information, vehicle type information, and SBOM illustrated in FIG. 2 are information obtained by being read from each DB by vulnerability management system 20.

Referring back to FIG. 1, vulnerability management system 20 is a system that executes processing for efficiently performing analysis to address vulnerability. Vulnerability management system 20 executes processing of grouping vehicle types (per-vehicle type analysis information) that are considered to share the same method for addressing the vulnerability, based on vehicle configuration information that indicates a vehicle configuration of each of the vehicle types. Accordingly, since processing for performing overlapping analyses and examinations is reduced, an improvement in efficiency of performing analysis for addressing vulnerability can be realized. Vulnerability management system 20 may further execute processing of grouping based on vulnerability analysis results.

Vulnerability management system 20 includes data receiver 21, determiner 22, notifier 23, display outputter 24, user inputter 25, and vulnerability management DB 26. Note that analysis support system 100 need only include at least data receiver 21 and determiner 22.

Data receiver 21 is a communication interface for receiving a vulnerability analysis result and/or a completion notification of a vulnerability analysis from vulnerability analysis system 10. For example, data receiver 21 receives the vulnerability analysis result illustrated in FIG. 2 from vulnerability analysis system 10. For example, data receiver 21 is configured so as to include a communication circuit (communication module).

Note that data receiver 21 is not limited to obtaining a vulnerability analysis result directly from vulnerability analysis system 10 and may obtain a vulnerability analysis result by, for example, reading a vulnerability analysis result stored in vulnerability management DB 26 or the like by vulnerability analysis system 10 from the DB. Data receiver 21 is an example of the data obtainer.

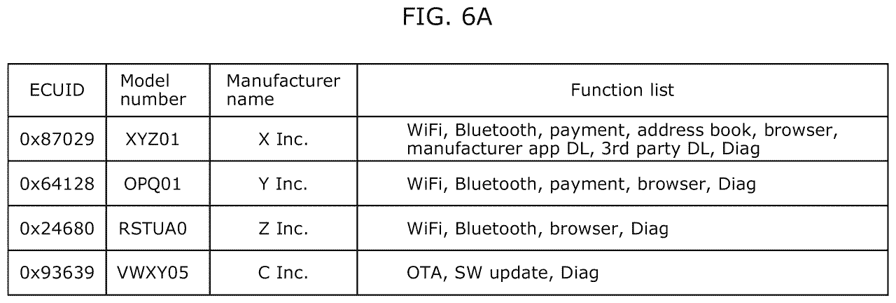

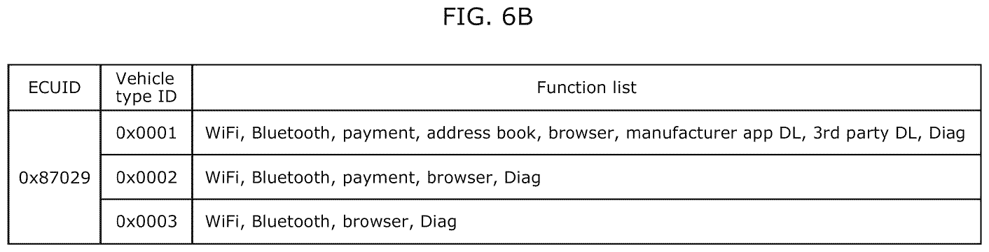

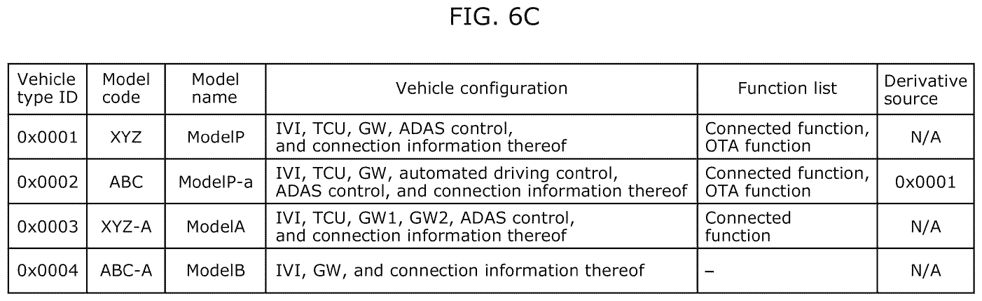

In addition, data receiver 21 obtains vehicle type information (refer to FIG. 6C to be described later) of each of a plurality of vehicle types provided with software having vulnerability from vehicle-related DB 60 or the like.

Furthermore, as information indicating an OTA (Over The Air) compatibility state of at least one of a target vehicle type and a device provided with software having vulnerability, data receiver 21 may obtain ECU vehicle type unique information (refer to FIG. 6C to be described later) and vehicle type information from vehicle-related DB 60 or the like.

Determiner 22 performs determination and implementation regarding grouping of vehicle types (per-vehicle type analysis information). For example, based on configuration information of each target vehicle type, determiner 22 groups vehicle types (per-vehicle type analysis information) considered to share the same countermeasure for vulnerability. Determiner 22 can also be described to perform a determination (first determination) for classifying target vehicle types into two or more groups based on the configuration information of the target vehicle types. For example, the target vehicle types include two or more vehicle types including a target ECU.

By one or more combinations of determination methods described below, determiner 22 determines whether or not a target vehicle type belongs to a group of vehicle types that are considered to have the same countermeasure for the vulnerability among extracted vehicle types. The determination is performed based on at least one of determination conditions that are “Condition 1. Degree of matching of vehicle configuration (including components and manufacturer)”, “Condition 2. Whether or not a target vehicle type is a derivative vehicle type”, “Condition 3. Degree of matching of ECU or module appearing on attack path”, and “Condition 4. Degree of matching of important point on attack path”.

Although strictness of grouping also depends on conditions and is not absolute, generally, the strictness is considered to have a tendency expressed as (severe) Condition 1> Condition 2> Condition 3> Condition 4 (greedy). In addition, determiner 22 may combine functional characteristics of the target ECU with determination. For example, the determination conditions may include “Condition 5. Similarity of available/unavailable setting of function of target ECU”.

“Condition 1. Degree of matching of vehicle configuration (including components and manufacturer)” is a condition regarding a degree of matching of vehicle configuration between a target vehicle type and other vehicle types among extracted vehicle types. The condition includes a degree of matching of a model number, a manufacturer name, connection information indicating a connection relationship, and the like of a vehicle-mounted device (ECU) such as a TCU (Telematics Control Unit), IVI (In-Vehicle Infotainment), a gateway (GW), or ADAS (Advanced Driver-Assistance Systems) that is included in each vehicle type. The degree of matching may be the number of matching vehicle-mounted devices. The degree of matching is an example of the level of matching. Vehicle configuration can be obtained based on the vehicle configuration illustrated in FIG. 6C to be described later.

“Condition 2. Whether or not a target vehicle type is a derivative vehicle type” indicates whether or not the target vehicle type is a derivative vehicle type of another vehicle type. Whether or not the target vehicle type is a derivative vehicle type can be determined based on a derivative source illustrated in FIG. 6C to be described later.

“Condition 3. Degree of matching of ECU or module appearing on attack path” indicates a degree of matching of an ECU or a module positioned on an expected attack path included in a vulnerability analysis result between a target vehicle type and other vehicle types among the extracted vehicle types. For example, the degree of matching may be the number of ECUs or modules with the same function that are positioned on the expected attack path. The degree of matching is an example of the level of matching. An ECU or a module appearing on an attack path can be obtained from the expected attack path illustrated in FIG. 2, the vehicle configuration illustrated in FIG. 6C, and the like.

“Condition 4. Degree of matching of important point on attack path” indicates a degree of matching of an entry point, a device including a security countermeasure function (for example, a gateway or a device including a firewall function), a target asset to be attacked, or the like, between the target vehicle type and other vehicle types among the extracted vehicle types. For example, the degree of matching may be the number of matching ECUs among an entry point, a device including a security countermeasure function, and a target asset to be attacked, between a target vehicle type and other vehicle types among the extracted vehicle types. At least one of the entry point, the device including a security countermeasure function, and the target asset to be attacked is an example of the predetermined point, and the degree of matching is an example of the level of matching.

“Condition 5. Similarity of available/unavailable setting of function of target ECU” indicates a degree of similarity of an available/unavailable setting of one or more functions included in a target ECU, between a target vehicle type and other vehicle types among the extracted vehicle types. For example, the available/unavailable setting may differ depending on a vehicle type. For example, the degree of similarity may be the number of same functions among available functions, between a target vehicle type and other vehicle types among the extracted vehicle types. The available/unavailable setting of a function of a target ECU can be obtained based on a list of functions illustrated in FIG. 6B to be described later.

Determiner 22 may determine whether or not grouping of vehicle types can be performed based on Condition 1 that is a degree of matching of the vehicle configuration between the vehicle types. Determiner 22 may determine whether or not grouping of vehicle types can be performed based on Condition 3 that is a degree of matching of one or more devices between the vehicle types. Determiner 22 may determine whether or not grouping of vehicle types can be performed based on Condition 4 that is a degree of matching of one or more predetermined points between the vehicle types.

For example, determiner 22 may determine a selection method of selecting one or more conditions from the above-described conditions, according to characteristics of a threat scenario (which asset is to be attacked in what way) of a target ECU. For example, characteristics include whether or not the target ECU is an entry point (a point of entry from outside), whether or not the target ECU possesses a target asset to be attacked, and the like.

For example, it is possible that, when the target ECU is an ECU that is an entry point and that possesses a target asset to be attacked, the determination of grouping is performed based on Condition 5, and when the target ECU is an ECU that is an entry point but does not possess a target asset to be attacked, the determination of grouping is performed based on a combination of Conditions 3 and 5.

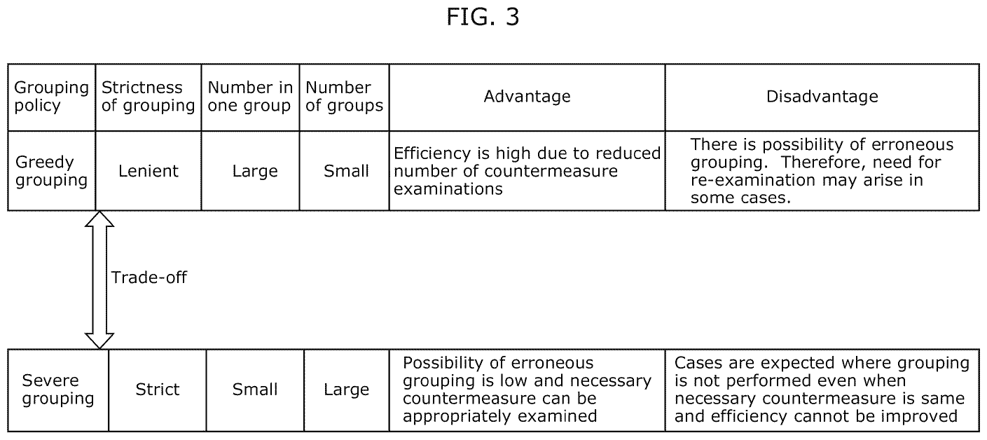

FIG. 3 is a diagram for describing a concept of grouping according to the present embodiment. In grouping, a trade-off may occur depending on accuracy (strictness) of the grouping. By making the determination of grouping more lenient or stricter, efficiency is emphasized in the case of the former and accuracy is emphasized in the case of the latter.

As illustrated in FIG. 3, grouping policies include greedy grouping in which strictness of grouping is lenient and severe grouping in which strictness of grouping is strict.

With greedy grouping, the number of vehicle types included in one group tends to be large and the number of groups tends to be small. In addition, an advantage of greedy grouping is that efficiency is high due to a reduced number of countermeasure examinations while a disadvantage of greedy grouping is that, given the possibility of erroneous grouping, the need for re-examination may arise in some cases.

With severe grouping, the number of vehicle types included in one group tends to be small and the number of groups tends to be large. In addition, an advantage of severe grouping is that the possibility of erroneous grouping is low and a necessary countermeasure can be appropriately examined while a disadvantage of severe grouping is that cases are expected where grouping is not performed even when the necessary countermeasure is the same and efficiency cannot be improved.

Which grouping policy tends to be dominant differs depending on a combination of conditions used in grouping by determiner 22.

For example, determiner 22 may perform the determination of grouping based on a value of a maximum risk among risks of vehicle types. For example, when the risk of the vehicle types is higher than a predetermined value (for example, risk 4 or risk 5), it is required to increase accuracy of the degree of matching between vehicle types in the same group. Therefore, determiner 22 performs the determination of grouping by combining Conditions 1 and 5. On the other hand, when the risk is lower than the predetermined value (for example, risk 1), determiner 22 combines Conditions 1 and 4 to prioritize increasing vehicle types to be allocated to the same group over increasing of the grouping accuracy. When the risk is intermediate (for example, risk 2 or risk 3), determiner 22 combines Conditions 3 and 5. Note that combinations of the conditions are not limited to the above. For example, three or more conditions may be combined or only one condition may be used.

Determiner 22 may perform the determination more severely when (i) the number of vehicle types with risks equal to or higher than a threshold or (ii) the number of pieces of per-vehicle type analysis information is greater (for example, Conditions 1 and 5).

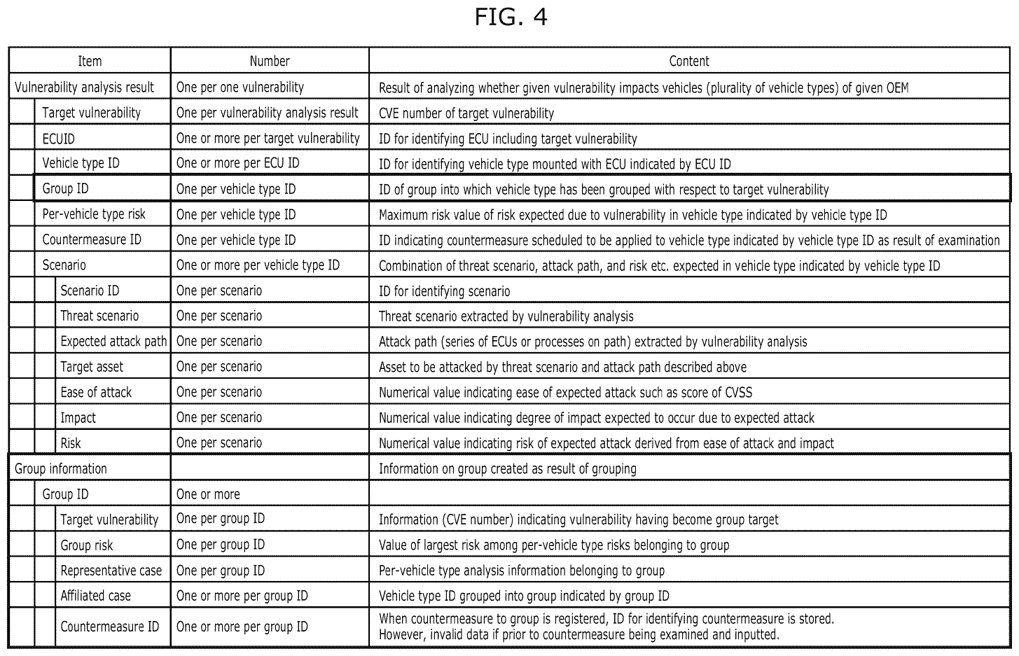

FIG. 4 is a diagram for describing information outputted from vulnerability management system 20 according to the present embodiment.

As illustrated in FIG. 4, the information includes a group ID and group information as indicated in the bold frames. For example, the information may be information created by adding a group ID and group information to information indicating a vulnerability analysis result.

The group ID indicates an ID of a group into which vehicle types have been grouped with respect to a target vulnerability (software in which vulnerability has been discovered).

The group information is information on a group created as a result of grouping and includes a target vulnerability, a group risk, a representative case, an affiliated case, and a countermeasure ID.

One target vulnerability is included in each group ID. The target vulnerability indicates information (for example, a CVE number) indicating a vulnerability to be analyzed for the group.

One group risk is included in each group ID and the group risk indicates a value of a largest risk among risks of respective vehicle types belonging to the group. The group risk may be used to determine an order of priority of analyses by, for example, analyst A. Note that the group risk is determined by, for example, determiner 22.

One representative case (representative case example) is included in each group ID and the representative case indicates per-vehicle type analysis information belonging to the group. The representative case can be described as indicating per-vehicle type analysis information to be a target of an analysis by analyst A. The per-vehicle type analysis information of a vehicle type having a highest risk (in other words, a group risk) among the vehicle types included in the group may be set as the representative case. Note that the representative case is determined by, for example, determiner 22.

One or more affiliated cases are included in each group ID and an affiliated case indicates a vehicle type ID having been grouped into the group indicated by the group ID.

One or more countermeasure IDs are included in each group ID and, when a countermeasure with respect to the group is registered, a countermeasure ID is an ID for identifying the countermeasure.

When there are a plurality of group IDs included in group information, the same number of the items described above as the number of group IDs are included in the group information.

Referring back to FIG. 1, notifier 23 notifies completion of grouping processing (determination processing) by determiner 22 to display outputter 24 and/or to analyst A by email or the like.

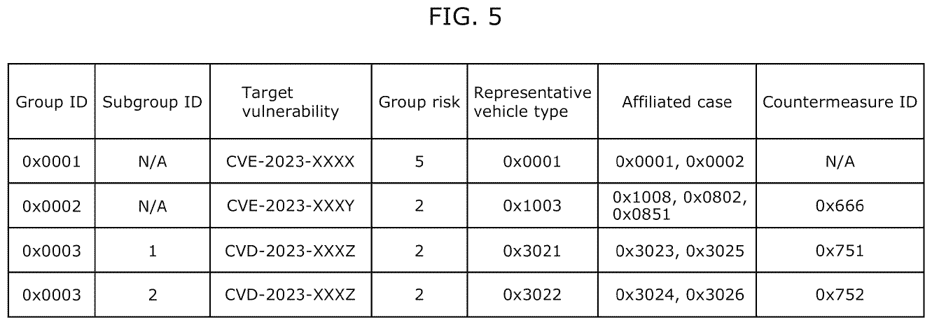

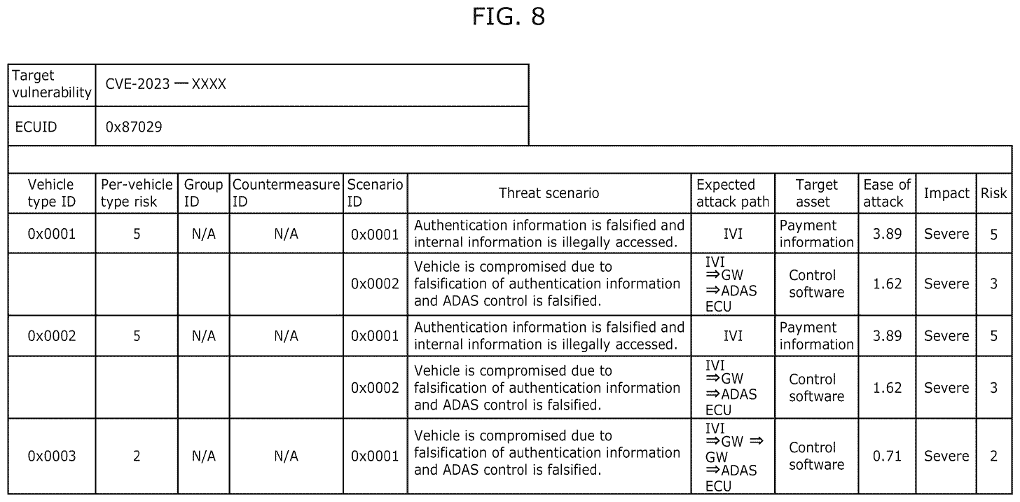

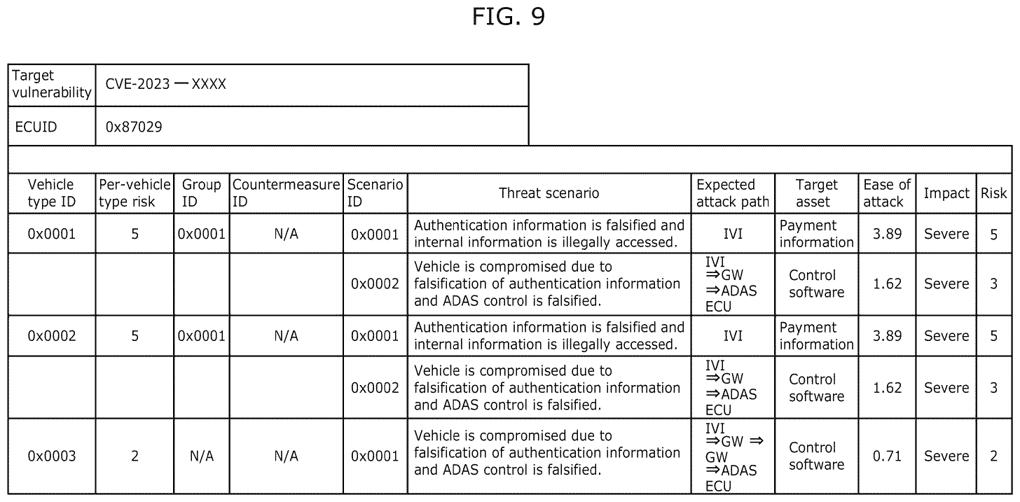

Display outputter 24 outputs information for causing display apparatus 30 to display the determination result by determiner 22. For example, display outputter 24 outputs information for displaying a grouping result (for example, group information illustrated in FIG. 5 or a vulnerability analysis result illustrated in FIG. 9 to be described later) and a vulnerability analysis result (for example, any of vulnerability analysis results illustrated in FIGS. 8, 9, and 17 to be described later) to display apparatus 30.

User inputter 25 accepts an input from analyst A. For example, user inputter 25 accepts an addressing method, a countermeasure result, a compatibility state (for example, an OTA compatibility state), and the like as user input and registers (stores) the user input in vulnerability management DB 26. While user inputter 25 is configured so as to include a keyboard, a mouse, a touch panel, or the like, user inputter 25 may be configured to accept input by voice.

Vulnerability management DB 26 is a database that stores various kinds of information including a vulnerability analysis result, group information (grouping result), and a compatibility state. FIG. 5 is a diagram illustrating an example of group information according to the present embodiment.

As illustrated in FIG. 5, the group information includes a group ID, a subgroup ID, a target vulnerability, a group risk, a representative vehicle type, an affiliated case, and a countermeasure ID.

The group ID is an ID for identifying a group.

When vehicle types included in one group is classified into two or more subgroups, the subgroup ID indicates an ID for identifying each of the classified subgroups. The example in FIG. 5 represents an example in which subgroups are not set in groups with group IDs of 0x0001 and 0x0002 and two subgroups with subgroup IDs of 1 and 2 are set in a group with a group ID of 0x0003.

The group risk indicates a risk corresponding to the group. The group risk is set based on a risk of each of one or more vehicle types included in the group. As the group risk, for example, a maximum value of the respective risks of one or more vehicle types included in the group may be set.

The representative vehicle type indicates the ID of one vehicle type that is representative of the one or more vehicle types included in the group. As the representative vehicle type, for example, the ID of a vehicle type having a risk that is set to a maximum value.

Referring back to FIG. 1, display apparatus 30 is an apparatus for displaying information from vulnerability management system 20 to analyst A. While display apparatus 30 is realized by, for example, a liquid crystal display apparatus, display apparatus 30 may be realized by, for example, a sounding apparatus (for example, a speaker) that outputs sound in the form of voice. Display apparatus 30 and the sounding apparatus are examples of the presentation apparatus. A presentation mode of the information in the presentation apparatus is not particularly limited.

When a new vulnerability is discovered, SBOM monitor 40 monitors whether there is a device (for example, an ECU) provided with software including the vulnerability using SBOM data (software configuration information) in SBOM DB 50 or the like and, when there is a device provided with the software, extracts information indicating the device. For example, SBOM monitor 40 obtains information on software having vulnerability from publicly available information. In addition, when a device provided with the software including the vulnerability is registered in SBOM DB 50, SBOM monitor 40 notifies vulnerability analysis management system 1.

SBOM DB 50 is a database storing software configuration information of each ECU. SBOM is a list made up of names of suppliers of all pieces of software including open-source software, component names, versions of components, a dependency relationship, a creator of SBOM data, a timestamp, and other unique identifiers that are used in each ECU mounted to a vehicle. In addition, SBOM also includes information related to vulnerability and may be used for vulnerability detection in components.

Vehicle-related DB 60 is a database that manages information related to vehicles. In the present embodiment, vehicle-related DB 60 manages information illustrated in FIGS. 6A to 6C. FIG. 6A is a diagram illustrating an example of ECU vehicle type common information according to the present embodiment. FIG. 6B is a diagram illustrating an example of ECU vehicle type unique information according to the present embodiment. FIG. 6C is a diagram illustrating an example of vehicle type information according to the present embodiment. FIGS. 6A to 6C represent design information stored in vehicle-related DB 60 in advance.

As illustrated in FIG. 6A, the ECU vehicle type common information indicates information shared by the respective vehicle types in the information related to the target ECU. The ECU vehicle type common information includes an ECU ID, a model number, a manufacturer name, and a function list.

The ECU ID indicates an ID of the target ECU.

The model number indicates a model number of the target ECU.

The manufacturer name indicates a manufacturer of the target ECU.

The function list indicates a list of respective functions included in the target ECU. The target ECU may include a plurality of functions. When the target ECU includes an OTA function, the function list includes information related to the OTA function. The function list is an example of information indicating the OTA compatibility state.

As illustrated in FIG. 6B, the ECU vehicle type unique information indicates information unique to each vehicle type in the information related to the target ECU. FIG. 6B illustrates the vehicle type unique information of the target ECU with an ECU ID of 0x87029. The ECU vehicle type unique information includes a vehicle type ID and a function list.

The vehicle type ID indicates an ID of a vehicle type mounted with the target ECU. FIG. 6B illustrates a case where the target ECU with an ECU ID of 0x87029 is mounted to three vehicle types having vehicle type IDs that are 0x0001 to 0x0003.

The function list indicates a list of functions set to available among the functions included in the target ECU. FIG. 6B illustrates an example where, in the vehicle type with a vehicle type ID of 0x0001, all of the functions included in the target ECU with an ECU ID of 0x87029 are set to available and, in the vehicle types with vehicle type IDs of 0x0002 and 0x0003, a part of the functions included in the target ECU with an ECU ID of 0x87029 are set to available while other functions are set to unavailable. In addition, even with a same ECU, functions set to available may differ when vehicle types differ.

As illustrated in FIG. 6C, the vehicle type information indicates information related to a target vehicle type. The vehicle type information includes a vehicle type ID, a model code, a model name, a vehicle configuration, a function list, and a derivative source.

The vehicle type ID indicates an ID of a target vehicle type.

The model code indicates a model that enables a grade of the vehicle type, specifications, and the like to be identified.

The model name indicates a model, a generation, and the like of the vehicle type.

The vehicle configuration (information indicating the vehicle configuration) indicates a configuration of a vehicle-mounted network in a vehicle. The vehicle configuration includes information indicating vehicle-mounted devices that are mounted to the vehicle and connection information of such devices. Examples of vehicle-mounted devices include an IVI, a TCU, a GW, ADAS control, and various ECUs. The connection information indicates a connection relationship among respective vehicle-mounted devices. For example, the vehicle configuration includes information related to one or more devices or one or more predetermined points (important points) arranged in an attack path that is predicted based on a vulnerability.

The function list indicates functions included in the target vehicle or functions set to available in the target vehicle. Examples of such functions include a connected function and an OTA function. The function list is an example of information indicating the OTA compatibility state.

When the vehicle type is a derivative vehicle type, the derivative source indicates an ID of the vehicle type of the derivative source. FIG. 6C illustrates an example where the vehicle type with a vehicle type ID of 0x0002 is a derivative vehicle type of the vehicle type with a vehicle type ID of 0x0001. In addition, a case where the derivative source is an empty field or invalid data (for example, N/A) indicates that there is no derivative source. In other words, in such a case, the vehicle type is a parent vehicle type.

### [2. Operation of Analysis Support System]

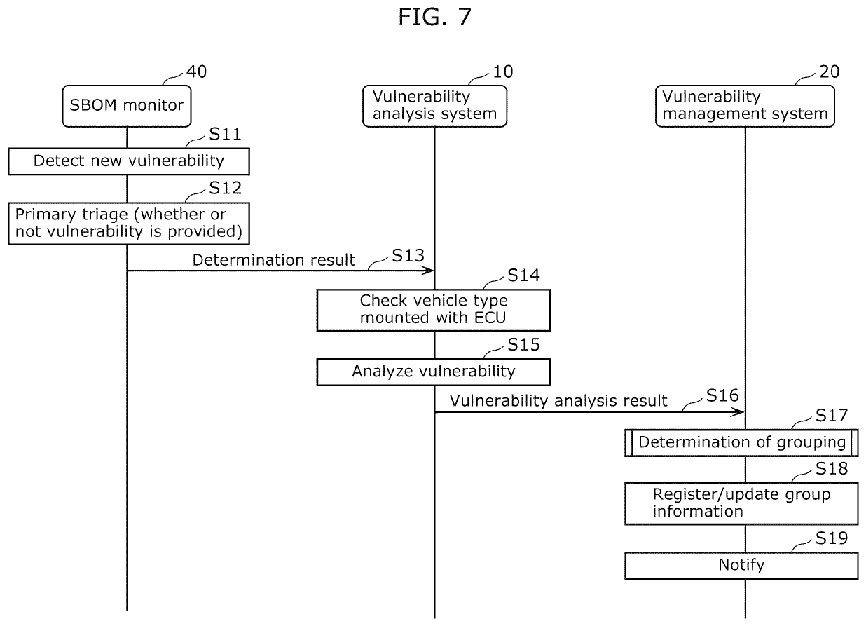

Next, an operation of analysis support system 100 configured as described above will be described with reference to FIGS. 7 to 17. FIG. 7 is a sequence diagram illustrating an operation (analysis support method) of analysis support system 100 according to the present embodiment.

As illustrated in FIG. 7, when SBOM monitor 40 detects a new vulnerability from publicly available information or the like (S11), SBOM monitor 40 executes primary triage (S12). SBOM monitor 40 determines whether or not the vulnerability is provided based on SBOM data and outputs a determination result to vulnerability analysis system 10 (S13). Determining whether or not the vulnerability is provided means determining a presence or absence of a device (such as an ECU) provided with software in which the vulnerability had been discovered. In addition, a determination result includes information indicating the device provided with software in which the vulnerability had been discovered.

Referring back to FIG. 7, next, vulnerability analysis system 10 checks a vehicle type mounted with the ECU (target vehicle type) (S14) and analyzes a vulnerability of the vehicle type mounted with the ECU (S15). Vulnerability analysis system 10 outputs a vulnerability analysis result (first vulnerability analysis result) to vulnerability management system 20 (S16). Data receiver 21 of vulnerability management system 20 obtains the vulnerability analysis result by receiving the vulnerability analysis result.

Note that in step S16, vulnerability analysis system 10 need only output information at least indicating target vulnerability among the respective items included in the vulnerability analysis result to vulnerability management system 20. In this case, vulnerability analysis system 10 may store information of other items not outputted to vulnerability management system 20 in step S16 in each DB (for example, vulnerability management DB 26) and data receiver 21 may obtain information of other items from each DB when necessary.

FIG. 8 is a diagram illustrating a vulnerability analysis result before grouping according to the present embodiment. FIG. 8 represents a vulnerability analysis result when three vehicle types with vehicle type IDs of 0x0001 to 0x0003 are determined to be target vehicle types. For example, the information illustrated in FIG. 8 is output from vulnerability analysis system 10 to vulnerability management system 20. Note that the information to be output from vulnerability analysis system 10 to vulnerability management system 20 need not include items of the group ID and the countermeasure ID.

As illustrated in FIG. 8, the vulnerability analysis result includes information of each item of the vulnerability analysis result illustrated in FIG. 2. Since determination processing of grouping by determiner 22 has not been executed, “N/A” is set to the group ID and the countermeasure ID. In addition, the vehicle types with vehicle type IDs of 0x0001 and 0x0002 include two scenarios. In this manner, in the analysis result of vulnerability analysis system 10, one target vehicle type (one target ECU) may include two or more scenarios. In this case, the analysis of each item of the scenario illustrated in FIG. 2 is to be performed with respect to each of the two or more scenarios.

In addition, the per-vehicle type risk is set based on a risk of each of the two or more scenarios. As the vehicle type risk, for example, a largest risk among the respective risks of the two or more scenarios is set.

Furthermore, the target asset may be stored information such as payment information or software such as control software.

In addition, the example in FIG. 8 represents an example where numerical values up to an upper limit of 5 are set as ease of attack.

Referring back to FIG. 7, next, determiner 22 of vulnerability management system 20 determines a group based on the configuration information of vehicles of the vehicle type mounted with the ECU (S17). Determiner 22 determines whether or not grouping is possible using at least one of the conditions described above and allocates vehicle types that can be grouped into the same group. The number of vehicle types included in one group is not particularly limited and need only be one or more.

Next, determiner 22 registers group information related to the group to vulnerability management DB 26 or updates the group information in vulnerability management DB 26 (S18). For example, when a new group is set in step S17, determiner 22 registers (stores) group information related to the group in vulnerability management DB 26. In addition, for example, when a determination to newly add a vehicle type to an existing group is made in step S17, determiner 22 updates group information that has already been registered by adding information of the added vehicle type to the group information.

When classifying into groups, for example, one vehicle type is classified into only one group with respect to one target vulnerability. In other words, determination by determiner 22 may be performed so that one vehicle type is never included in two or more groups with respect to one target vulnerability.

FIG. 9 is a diagram illustrating a vulnerability analysis result after grouping according to the present embodiment.

As illustrated in FIG. 9, since the vehicle types with the vehicle type IDs of 0x0001 and 0x0002 have been determined as one group, a same group ID is set. In this manner, information on the vulnerability analysis result may be updated based on the determination result of step S17. Note that the group ID of the vehicle type with the vehicle type ID of 0x0003 remains “N/A” since the vehicle type had not been classified into any group.

Referring back to FIG. 7, next, when the determination processing by determiner 22 is completed, notifier 23 notifies the completion to analyst A (S19). Notifier 23 may notify the completion to display outputter 24 or a mobile terminal in the possession of analyst A. Accordingly, analyst A can be notified of the completion of processing of grouping.

Note that display outputter 24 may cause display apparatus 30 to display group information, the vulnerability analysis result illustrated in FIG. 9, and the like instead of the notification by notifier 23 or together with the notification by notifier 23.

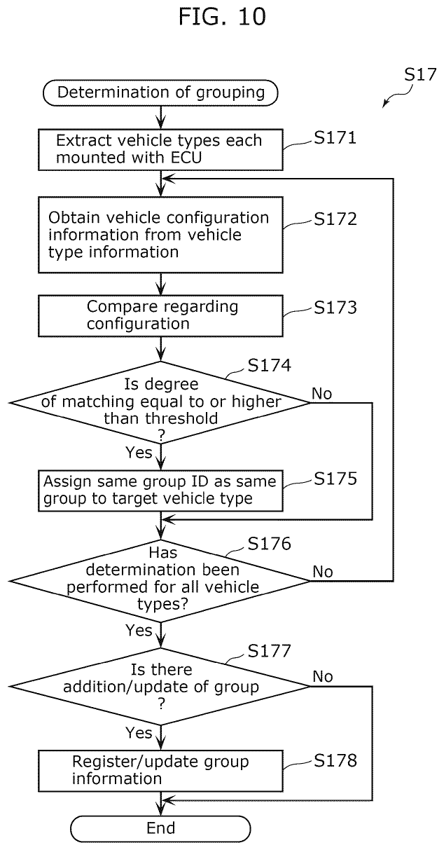

Next, respective examples of the processing of determining a group illustrated in FIG. 7 will be described with reference to FIGS. 10 to 14. FIGS. 10 to 14 are flow charts illustrating respective examples of a detailed operation (analysis support method) of step S17 illustrated in FIG. 7. Processing illustrated in FIGS. 10 to 14 is executed by, for example, determiner 22.

As illustrated in FIG. 10, determiner 22 extracts a vehicle type (target vehicle type) mounted with an ECU (target ECU) from a plurality of vehicle types (S171), and obtains vehicle configuration information (information indicating the vehicle configuration in FIG. 6C) of the vehicle type from the vehicle type information (refer to FIG. 6C) of the extracted vehicle type (S172). If determiner 22 extracts a plurality of vehicle types, determiner 22 obtains the pieces of vehicle configuration information of the extracted vehicle types.

Next, determiner 22 obtains a degree of matching of configuration by comparing a configuration of a target vehicle type with a configuration of each of the other vehicle types among the extracted vehicle type between the extracted vehicle types based on the pieces of the vehicle configuration information of the extracted vehicle types (S173), and determines, for the target vehicle type, whether or not the degree of matching is equal to or greater than a threshold (S174). If determiner 22 determines, for the target vehicle type, that the degree of matching is equal to or greater than the threshold (Yes in S174), determiner 22 allocates the target vehicle type into a group of vehicle types that are considered to have the same countermeasure for the vulnerability among the extracted vehicle types and assigns a group ID of the group to the target vehicle type (S175). In other words, determiner 22 determines vehicle types each having a degree of matching that is equal to or greater than the threshold to be allocated to the same group and assigned with the same group ID. On the other hand, if determiner 22 determines, for the target vehicle type, that the degree of matching is not equal to or greater than the threshold (No in S174), determiner 22 does not assign the group ID to the target vehicle type, or assigns another group ID different from the above group ID to the target vehicle type, and then proceeds to step S176.

Next, determiner 22 determines whether or not the above determination has been performed for all of the extracted vehicle types (S176). If determiner 22 determines that the determination has been performed for all of the extracted vehicle types (Yes in S176), determiner 22 determines whether or not there is group adding or group updating (S177). The group adding means that a group of vehicle types has been added, and the group updating means that a vehicle type has been newly added to an existing group. If determiner 22 determines that there is group adding or group updating (Yes in S177), determiner 22 registers group information of a newly added group into vulnerability management DB 26 or updates group information of a group newly added with a vehicle type into vulnerability management DB 26 (S178), but if determiner 22 determines that there is no group adding or group updating (No in S177), determiner 22 ends the processing.

In addition, if determiner 22 determines that the above determination has not been performed for all of the extracted vehicle types (No in S176), determiner 22 returns to step S172 and continues processing of step S172 and subsequent steps with respect to a next target vehicle type among the extracted vehicle types.

If a vehicle type compatible with OTA and a vehicle type not compatible with OTA coexist in one group, determiner 22 may add information (for example, a flag) indicating the coexistence to group information or the like of the group. Accordingly, analyst A can be notified of the coexistence.

Note that the determination based on the degree of matching of configuration between the extracted vehicle types, the determination as to whether or not each of the extracted vehicle types is a derivative vehicle type, and the like are not dependent on the target vulnerability. Therefore, a result of a previously-performed group determination may be stored as a previous grouping record and group determination may be performed using the previous grouping record.

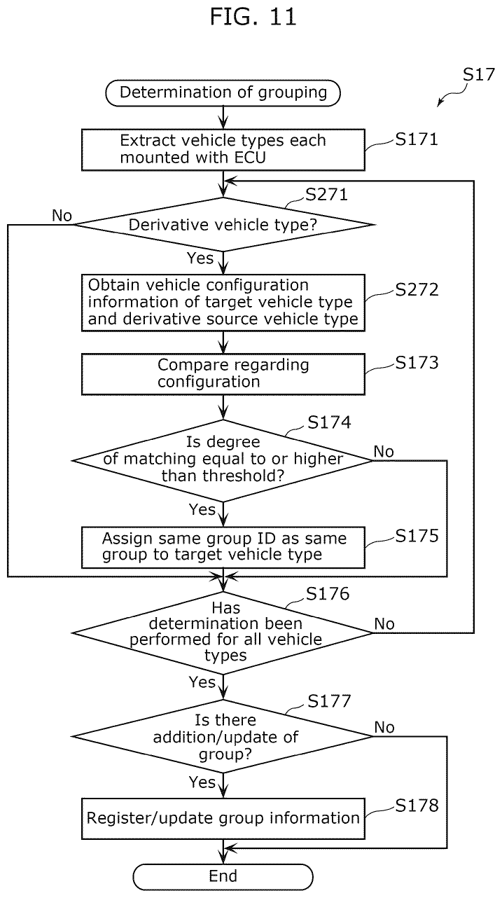

Next, an operation of narrowing down target vehicle types to be analysis targets based on whether or not each of the target vehicle types is a derivative vehicle type will be described with reference to FIG. 11.

As illustrated in FIG. 11, after step S171, determiner 22 determines, for each of the extracted vehicle types, whether or not the vehicle type (target vehicle type) is a derivative vehicle type that is derived from another vehicle type (derivative source vehicle type) among the extracted vehicle types, based on the vehicle type information of the target vehicle type (S271). More specifically, determiner 22 determines whether or not the target vehicle type is a derivative vehicle type, based on information indicating a derivative source in the vehicle information of the target vehicle type. In the example of FIG. 6C, only a vehicle type ID of 0x0002 among vehicle type IDs 0x0001 to 0x0004 is determined as a derivative vehicle type.

If determiner 22 determines that the target vehicle type is a derivative vehicle type of another vehicle type among the extracted vehicle types (Yes in S271), determiner 22 proceeds to step S272. On the other hand, if determiner 22 determines that the target vehicle type is not a derivative vehicle type of any vehicle type among the extracted vehicle types (No in S271), determiner 22 proceeds to step S176. In a case of No in step S271, the subsequent determination of grouping is skipped for the target vehicle type.

In the case of Yes in step S271, determiner 22 obtains vehicle configuration information of the target vehicle type and vehicle configuration information of the vehicle type (derivative source vehicle type) from which the target vehicle type is derived (S272). Then, in step S173, determiner 22 obtains a degree of matching of configuration by comparing a configuration of the target vehicle type and a configuration of the derivative source vehicle type.

Accordingly, since the number of vehicle types to be targets of the determination of grouping can be reduced, a processing amount of determiner 22 can be reduced. When a difference between a derivative vehicle type and its derivative source vehicle type is expected to be small according to a vehicle manufacturer or the like, it is possible to allocate such a derivative vehicle type into the same group of the derivative source vehicle type because the derivative vehicle type is derived from the derivative source vehicle type (based on a determination of Yes in step S271), and the operation may proceed to step S175 from step S271 by skipping step S272, step S173, and step S174.

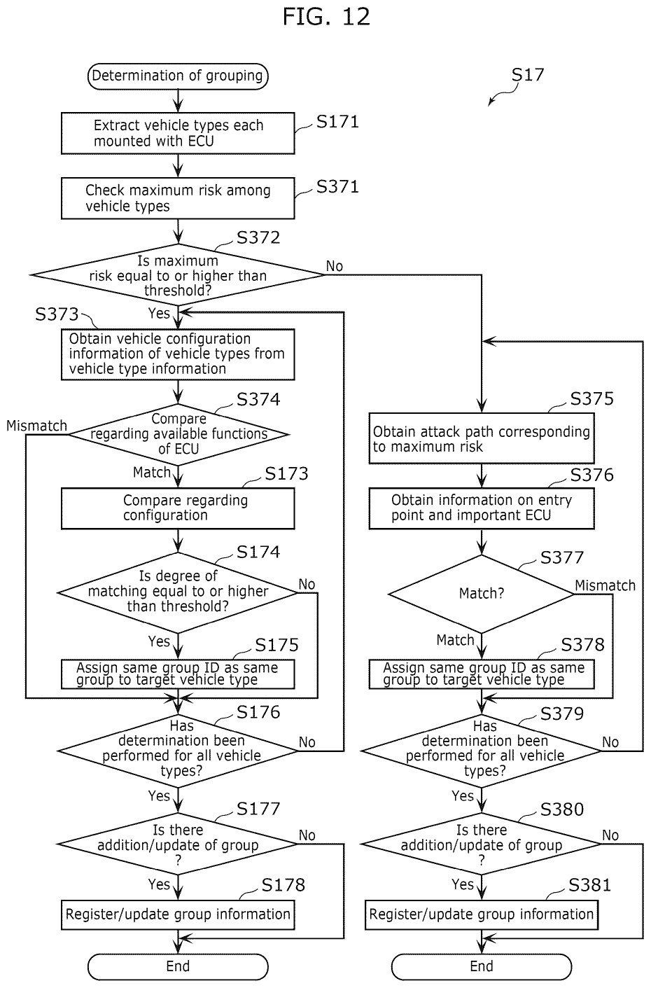

Next, an operation of changing a condition to be used in the determination of grouping according to a value of a maximum risk will be described with reference to FIG. 12.

As illustrated in FIG. 12, after step S171, determiner 22 checks a maximum risk among the extracted vehicle types based on the vulnerability analysis result (S371), and determines whether or not the maximum risk is equal to or greater than a threshold (S372). More specifically, determiner 22 obtains risks of the extracted vehicle types each mounted with a target ECU from the vulnerability analysis result, then sets the largest risk among the obtained risks as a maximum risk, and determines whether or not the maximum risk is equal to or greater than the threshold.

Here, the maximum risk is set for each of different vulnerabilities, and the determination of step S372 is executed for each of the vulnerabilities.

Next, if determiner 22 determines that the maximum risk is equal to or greater than the threshold (Yes in S372), determiner 22 obtains vehicle configuration information (in this case, for example, the ECU vehicle type unique information illustrated in FIG. 6B) of the extracted vehicle types from vehicle-related DB 60 (S373). Then, determiner 22 determines, for each of the extracted vehicle types, whether available functions of the ECU match between the target vehicle type and other vehicle types among the extracted vehicle types, based on the vehicle configuration information (S374). If determiner 22 determines that the available functions of the ECU match between the target vehicle type and other vehicle types among the extracted vehicle types (match in S374), determiner 22 proceeds to the subsequent determination of grouping.

On the other hand, if determiner 22 determines that the available functions of the ECU do not match between the target vehicle type and other vehicle types among the extracted vehicle types (mismatch in S374), determiner 22 proceeds to step S176. In a case of the mismatch in step S374, the determination of grouping is skipped for the target vehicle type. Accordingly, since the number of vehicle types to be targets in the determination of grouping can be reduced, a processing amount of determiner 22 can be reduced.

If determiner 22 determines that the above determination has not yet been performed for all of the extracted vehicle types (No in S176), determiner 22 returns to step S373 and continues processing of step S373 and its subsequent steps for a next target vehicle type.

In S372, if determiner 22 determines that the maximum risk is not equal to or greater than the threshold (No in S372), determiner 22 obtains an attack path corresponding to the maximum risk (S375). For example, determiner 22 obtains, as the attack path corresponding to the maximum risk, an attack path (expected attack path) included in a vulnerability analysis result of a vehicle type having the maximum risk.

Next, based on the vehicle configuration information, determiner 22 obtains information on an entry point and/or an important ECU of the target vehicle type which are on the attack path (S376). For example, the important ECU may be an ECU having a security countermeasure function such as a gateway or a firewall function, an ECU to be a target asset to be attacked, or a combination thereof. The entry point and the important ECU are important points on the attack path.

Next, determiner 22 determines whether or not the ECU to be an entry point or an important point matches between the target vehicle type and other vehicle types among the extracted vehicle types (S377). If determiner 22 determines that the ECU matches between the target vehicle type and other vehicle types among the extracted vehicle types (match in S377), determiner 22 proceeds to step S378. However, if determiner 22 determines that the ECU does not match between the target vehicle type and other vehicle types among the extracted vehicle types (mismatch in S377), determiner 22 proceeds to step S379.

Since an operation in steps S378 to S381 is the same as the operation in steps S175 to S178, a description thereof will be omitted.

As described above, when the risk is high, determiner 22 performs the determination of grouping using conditions (in the example in FIG. 12, Conditions 1 and 5) for increasing the accuracy of the degree of matching in the group. On the other hand, when the risk is low, determiner 22 performs the determination of grouping using another condition (in the example in FIG. 12, Condition 4) for prioritizing increasing of the number of vehicle types to be allocated to the same group over increasing of the accuracy of the degree of matching in the group. Note that vulnerability management DB 26 may store a table in which maximum risks and conditions used for determination of grouping are associated with each other, and determiner 22 may determine a condition based on the table. In addition, while Conditions 1 and 5 and Condition 4 are used in the description given above, conditions and combinations of conditions to be used are not limited thereto. Furthermore, three or more conditions or combinations of conditions may be set according to the risk.

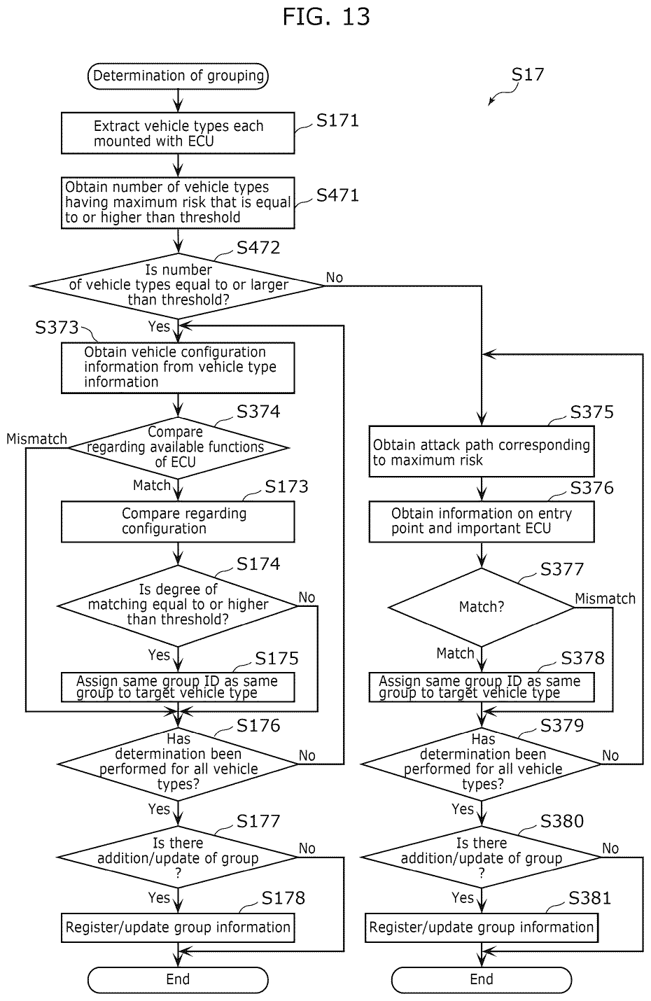

Next, an operation in a case where a severer determination condition is used as the number of vehicle types with risks equal to or higher than a threshold is greater will be described with reference to FIG. 13.

As illustrated in FIG. 13, after step S171, determiner 22 obtains the number of vehicle types each having a maximum risk that is equal to or greater than the threshold (S471). For example, determiner 22 may obtain the number of vehicle types by comparing, for each vehicle type (target vehicle type) mounted with the ECU (target ECU), the maximum risk of the vehicle type and the threshold with each other. The maximum risk of a vehicle type is, for example, a risk indicated by the per-vehicle type risk.

Next, determiner 22 determines whether or not the number of vehicle types obtained in step S471 is equal to or greater than a threshold (S472), if it is determined that the number of vehicle types is equal to or greater than the threshold (Yes in S472), determiner 22 proceeds to step S373, but if it is determined that the number of vehicle types is not equal to or greater than the threshold (No in S472), determiner 22 proceeds to step S375. Since subsequent processing is the same as FIG. 12, a description thereof will be omitted.

As described above, when the number of vehicle types each having the maximum risk that is equal to or greater than a threshold is large, determiner 22 performs the determination of grouping using a condition (in the example in FIG. 13, Conditions 1 and 5) for increasing the accuracy of the degree of matching in the same group. On the other hand, when the number of vehicle types each having the maximum risk that is equal to or greater than a threshold is small, determiner 22 performs the determination of grouping using a condition (in the example in FIG. 13, Condition 4) for prioritizing increasing of the number of vehicle types to be allocated to the same group over increasing of the accuracy of the degree of matching in the group. Note that vulnerability management DB 26 may store a table in which the number of vehicle types each having the maximum risk that is equal to or greater than a threshold and conditions used for determination are associated with each other and determiner 22 may determine a determination condition based on the table. In addition, while Conditions 1 and 5 and Condition 4 are used in the description given above, conditions and combinations of conditions to be used are not limited thereto. Furthermore, three or more conditions or combinations of conditions may be set according to the number of vehicle types.

As illustrated in FIG. 12 and FIG. 13 described above, determiner 22 may perform a first determination based on a determination condition or a combination of two or more determination conditions that is determined based on at least one of vehicle type information and a vulnerability analysis result among a plurality of determination conditions.

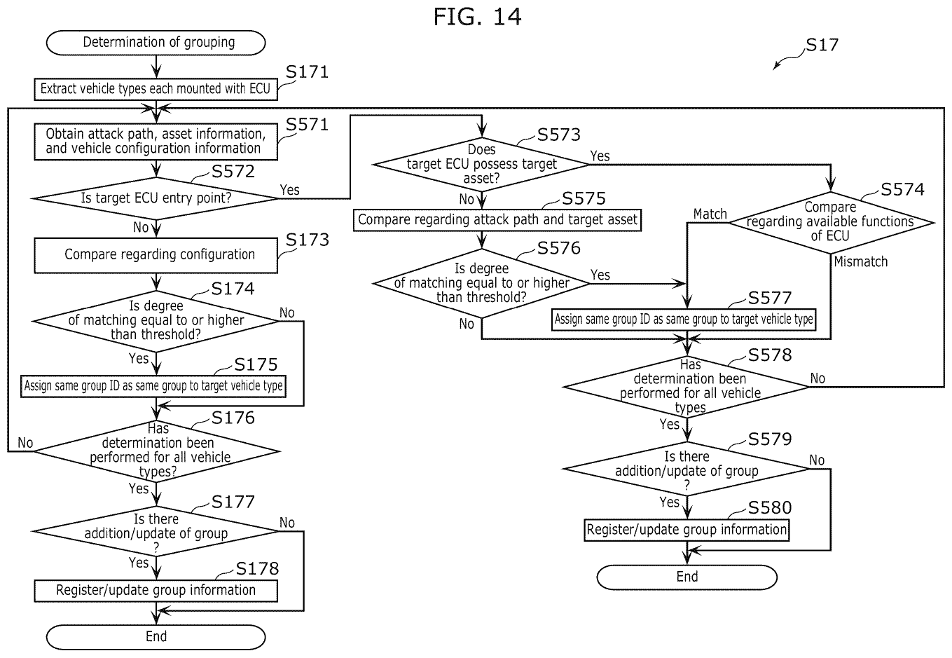

Next, an operation in a case where a determination condition in accordance with characteristics of a threat scenario of a target ECU is used will be described with reference to FIG. 14.

As illustrated in FIG. 14, after step S171, determiner 22 obtains an attack path, asset information, and vehicle configuration information in a vehicle type (target vehicle type) mounted with the ECU from vehicle-related DB 60 (S571), and determines whether or not the target ECU is an entry point based on the obtained information (S572). If determiner 22 determines that the target ECU is an entry point (Yes in S572), determiner 22 proceeds to step S573, but if determiner 22 determines that the target ECU is not an entry point (No in S572), determiner 22 proceeds to step S173.

Next, if determiner 22 determines, for each of the extracted vehicle types, that the target ECU is an entry point, determiner 22 further determines whether or not the target ECU has a target asset to be attacked (S573). If determiner 22 determines that the target ECU has a target asset to be attacked (Yes in S573), determiner 22 further checks available functions of the target ECU (S574). If determiner 22 determines that the available functions of the target ECU match between the target vehicle type and other vehicle types among the extracted vehicle types (match in S574), determiner 22 proceeds to step S577, but if determiner 22 determines that the available functions of the target ECU do not match between the target vehicle type and other vehicle types among the extracted vehicle types (mismatch in S574), determiner 22 proceeds to step S578.

On the other hand, if determiner 22 determines that the target ECU does not have a target asset to be attacked (No in S573), determiner 22 performs comparing regarding the attack path and the target asset between the target vehicle type and other vehicle types among the extracted vehicle types (S575), and determines whether or not a degree of the matching is equal to or higher than a threshold (S576).

Since an operation in steps S576 to S580 is the same as the operation in steps S174 to S178, a description thereof will be omitted.

In this manner, determiner 22 may use a determination condition in accordance with characteristics of a threat scenario of a target ECU such as whether or not the target ECU is an entry point or whether or not the target ECU possesses a target asset to be attacked.

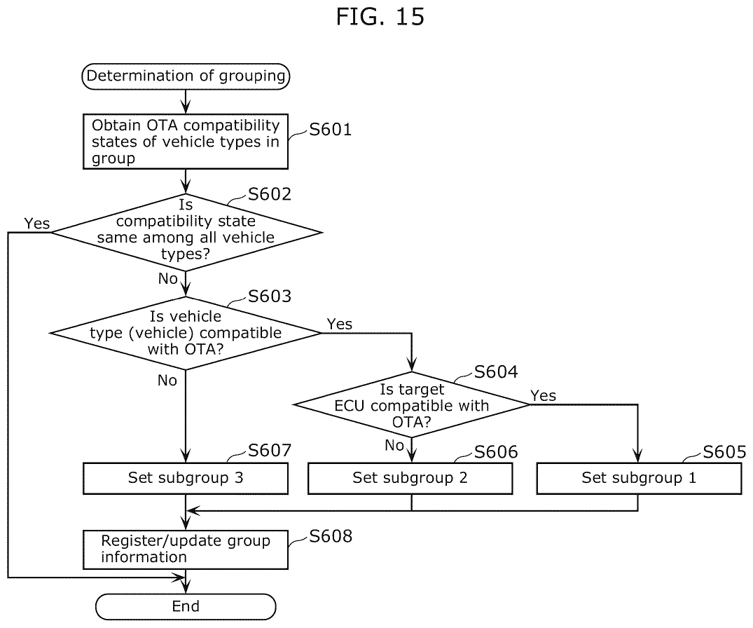

Next, processing after determination of a group will be described with reference to FIGS. 15 to 17. First, processing of classifying a plurality of vehicle types included in one group into two or more subgroups will be described with reference to FIG. 15. FIG. 15 is a flow chart illustrating an operation (analysis support method) of determining a subgroup after a determination of a group according to the present embodiment. Steps S601 to S607 illustrated in FIG. 15 are executed between step S17 and step S18 illustrated in FIG. 7. In addition, the processing illustrated in FIG. 15 may be executed with respect to each of a plurality of groups created in step S17.

As illustrated in FIG. 15, determiner 22 obtains OTA compatibility states of vehicle types in a group (S601). Determiner 22 obtains the OTA compatibility states of one or more vehicle types included in the group based on the pieces of vehicle type information (refer to FIG. 6C) of the one or more vehicle types.

Next, determiner 22 determines whether or not a compatibility state is the same among all of the vehicle types included in the group (S602). More specifically, for example, it is determined whether or not all of the vehicle types in the group are compatible with OTA, or whether or not the target ECUs mounted on the vehicle types in the group are compatible with OTA. If determiner 22 determines that the compatibility state is the same in all of the vehicle types included in the group (Yes in S602), since a countermeasure is considered to be shared by all of the vehicle types, the processing is ended. On the other hand, if determiner 22 determines that the compatibility state is not the same in all of the vehicle types included in the group (No in S602), determiner 22 determines, for each of the vehicle types, whether or not the vehicle type (vehicle) is compatible with OTA based on vehicle information (S603).

If determiner 22 determines that the target vehicle type (vehicle) is compatible with OTA (Yes in S603), determiner 22 further determines whether or not an ECU of the target vehicle type is compatible with OTA based on ECU vehicle type unique information of the ECU (refer to FIG. 6B) (S604). If determiner 22 determines that the ECU is compatible with OTA (Yes in S604), determiner 22 classifies the target vehicle type into subgroup 1 (S605). On the other hand, if determiner 22 determines that the ECU is not compatible with OTA (No in S604), determiner 22 classifies the target vehicle type into subgroup 2 (S606). If determiner 22 determines that the target vehicle type (vehicle) is not compatible with OTA (No in S603), determiner 22 classifies the target vehicle type into subgroup 3 (S607).

Next, determiner 22 registers group information regarding the above sub-grouping to vulnerability management DB 26 or updates the group information in vulnerability management DB 26 according to a result of the sub-grouping (S608). Determiner 22 registers an ID corresponding to the sub-grouping as a subgroup ID included in group information.

In this case, countermeasures with respect to vehicle types of each of the three subgroups may differ. For example, a vehicle type included in subgroup 1 may be addressed by updating vulnerability of the target ECU by communication or the like. In addition, for example, when an ECU which is not a target ECU and which is positioned on an attack path to a target ECU is compatible with OTA, a vehicle type included in subgroup 2 may be addressed by updating so as to improve security performance of the ECU that is compatible with OTA. Furthermore, since a countermeasure via communication cannot be applied to a vehicle type included in subgroup 3, for example, the vehicle type can be addressed by bringing the vehicle type to a repair shop or the like.

In this manner, determiner 22 classifies vehicle types included in one group into three subgroups that may have different countermeasures depending on the OTA compatibility state of each of the vehicle type and its target ECU. Note that the number of divisions into subgroups is not limited to three and may be two or four or more. In addition, the countermeasure of at least one subgroup among a plurality of subgroups need only differ from the countermeasures of other subgroups.

For example, processing of classifying into subgroups may be executed based on an instruction by analyst A or executed with respect to groups that include a predetermined number of vehicle types or more.

Note that determiner 22 may further determine whether or not important ECUs such as an entry point and a gateway are compatible with OTA and perform classification into subgroups according to the determination result. Determiner 22 may determine whether or not an ECU on an attack path to a target ECU or in a periphery of the target ECU (for example, an ECU connected to the target ECU) is compatible with OTA based on vehicle type information. In this case, a vehicle type determined to be compatible with OTA and a vehicle type determined to be not compatible with OTA are to be classified into different subgroups.

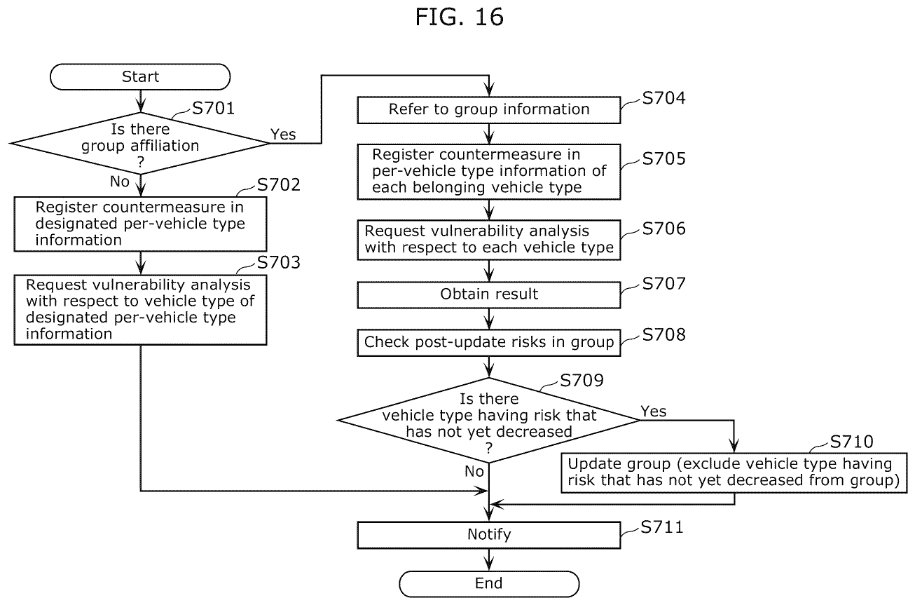

Next, processing of examining a countermeasure determined by analyst A will be described with reference to FIG. 16. FIG. 16 is a flow chart illustrating an operation (analysis support method) of examining a countermeasure according to the present embodiment.

As illustrated in FIG. 16, determiner 22 determines whether or not a target vehicle type belongs to any group (whether or not there is group affiliation) (S701).

Next, if determiner 22 determines that a target vehicle type does not belong to any group (No in S701), determiner 22 registers a countermeasure in designated per-vehicle type information (for example, a vulnerability analysis result) (S702), and requests vulnerability analysis system 10 to perform vulnerability analysis for a vehicle type of the designated per-vehicle type information (S703).

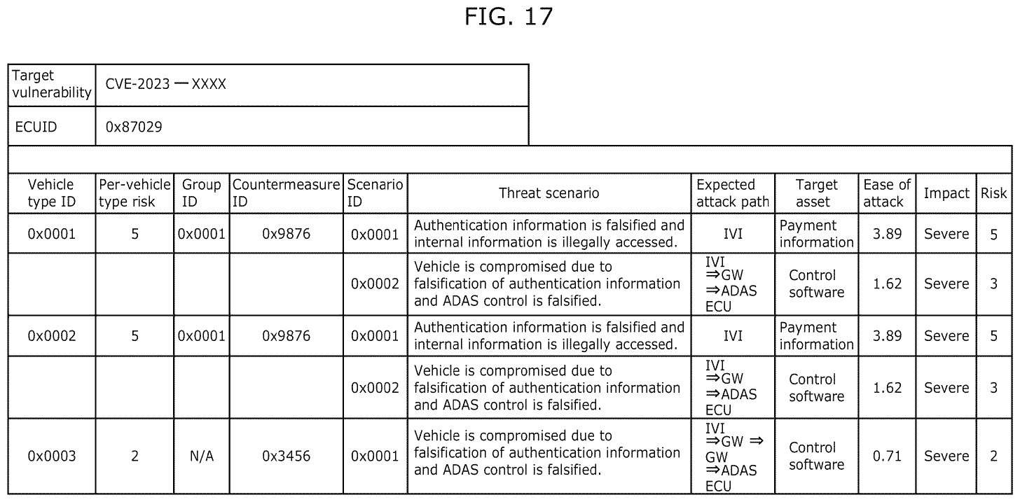

FIG. 17 is a diagram illustrating a vulnerability analysis result after registration of a countermeasure according to the present embodiment. FIG. 17 illustrates an example in which a countermeasure is registered (added) to a vulnerability analysis result.

As illustrated in FIG. 17, an ID according to a registered countermeasure is added to a countermeasure ID in the vulnerability analysis result. In FIG. 17, the countermeasure IDs of vehicle types with vehicle type IDs of 0x0001 and 0x0002 with a same group ID are the same. In addition, the countermeasure ID of a vehicle type with a vehicle type ID of 0x0003 to which a group ID has not been set differs from the countermeasure ID of the vehicle types with the vehicle type IDs of 0x0001 and 0x0002. Note that display outputter 24 may cause display apparatus 30 to display the information illustrated in FIG. 17.

In addition, if determiner 22 determines that the target vehicle type belongs to a group (Yes in S701), determiner 22 refers to group information of the group to which the target vehicle type belongs (S704). For example, determiner 22 obtains the group information of the group from vulnerability management DB 26.

Next, determiner 22 registers a countermeasure in per-vehicle type information of each of vehicle types belonging to the group (S705), and requests vulnerability analysis system 10 to perform vulnerability analysis with respect to each of the vehicle types (S706). In addition, data receiver 21 obtains a result (second vulnerability analysis result) of a vulnerability analysis of each of the vehicle types from vulnerability analysis system 10 (S707). In other words, for example, for each of two or more classified groups, data receiver 21 obtains a vulnerability analysis result of a target vehicle type under the assumption that countermeasure for vulnerability of software in the target vehicle type has already been executed.

Note that a countermeasure has not been fixed at this time point and vulnerability analysis system 10 performs a vulnerability analysis of each vehicle type when it is assumed that a countermeasure determined by analyst A has been executed. A risk of a vehicle type included in the result of the vulnerability analysis is also described as a post-update risk.

Next, determiner 22 checks post-update risks in the group (S708) and determines whether or not there is a vehicle type having a risk that has not yet decreased (S709). Determiner 22 determines, when it is assumed that countermeasures in the vehicle types have been executed, whether or not risk decreases as compared to before executing the countermeasure with respect to each vehicle type. If determiner 22 determines that there is a vehicle type having a risk that has not yet decreased (Yes in S709), determiner 22 updates the group (S710). Determiner 22 excludes the vehicle type having a risk that has not yet decreased from the group. For example, determiner 22 deletes the vehicle type ID of the vehicle type having a risk that has not yet decreased, from the group information. In addition, determiner 22 may add information indicating that the risk has not decreased to vehicle type information or the like of the excluded vehicle type.

On the other hand, if determiner 22 determines that there is no vehicle type having a risk that has not yet decreased (No in S709), determiner 22 proceeds to step S711.

Next, notifier 23 notifies analyst A of a result of the vulnerability analysis by vulnerability analysis system 10, group information after the update, and the like (S711). Accordingly, analyst A can comprehend how a risk, a group, or the like changes due to a countermeasure determined by analyst A himself/herself or, in other words, whether or not the countermeasure is effective. Such information may be effective when analyst A finally determines a countermeasure.

### OTHER EMBODIMENTS

Although the analysis support system and the like according to one or more aspects of the present disclosure has been described based on an embodiment, the present disclosure is not limited to this embodiment. Those skilled in the art will readily appreciate that embodiments arrived at by making various modifications to the above embodiment or embodiments arrived at by selectively combining elements disclosed in the above embodiment without materially departing from the scope of the present disclosure may be included within one or more aspects of the present disclosure.

Each of the elements in each of the above embodiments may be configured in the form of an exclusive hardware product, or may be realized by executing a software program suitable for the element. Each of the elements may be realized by means of a program executing unit, such as a Central Processing Unit (CPU) or a processor, reading and executing the software program recorded on a recording medium such as a hard disk or semiconductor memory.

The order of steps in each flowchart is an example for explaining the present disclosure in more detail. The order of steps may be changed, or a part of the steps may be performed simultaneously with (in parallel to) another part of the steps. It is also possible to skip a part of the steps.

The dividing of the functional blocks in each of the block diagrams is one example. It is possible that a plurality of functional blocks are implemented into a single functional block, that a single functional block is divided into a plurality of functional blocks, and that a function executed by a functional block is partially executed by another functional block. Furthermore, similar functions of a plurality of functional blocks may be executed by a single hardware or software in parallel or by time division.

The vulnerability analysis system may be implemented to a single device or include a plurality of devices. If the vulnerability analysis system includes a plurality of devices, the way of allocating the constituent elements included in the vulnerability analysis system to the plurality of devices is not limited. If the vulnerability analysis system includes a plurality of devices, a communication method between the plurality of devices is not limited. The communication method may be wireless communication or wired communication. It is also possible to combine wireless communication and wired communication between the plurality of devices.

Each constituent element described in the above embodiments may be implemented to software, or typically implemented into a Large Scale Integration (LSI) which is an integrated circuit. These may be integrated separately, or a part or all of them may be integrated into a single chip. Note that here, the terminology “system LSI circuit” is used, but depending on the degree of integration, the circuit may also referred to as IC, LSI circuit, super LSI circuit, or ultra LSI circuit. Moreover, the method of circuit integration is not limited to LSI. Integration may be realized with a specialized circuit or a general purpose processor. After the LSI circuit is manufactured, a field programmable gate array (FPGA) or a reconfigurable processor capable of reconfiguring the connections and settings of the circuit cells in the LSI circuit may be used. Further, if an integrated circuit technology that replaces LSI emerges from advances in or derivations of semiconductor technology, integration of functional blocks using such technology may also be used.

The system LSI is a super multi-function LSI that is a single chip into which a plurality of constituent elements are integrated. More specifically, the system LSI is a computer system including a microprocessor, a Read Only Memory (ROM), a Random Access Memory (RAM), and the like. The ROM holds a computer program. The microprocessor operates according to the computer program, thereby causing the system LSI to execute its functions.

An aspect of the present disclosure may be a computer program for causing a computer to execute each characteristic step included in the analysis support method which is presented in any of FIGS. 7 and 10 to 16.

For example, the present disclosure may be implemented to a program that causes the computer to execute the above-described processing. Furthermore, an aspect of the present disclosure may be implemented to a non-transitory computer-readable recording medium storing such a program. For example, such a program may be recorded on a recording medium and distributed. For example, the distributed program may be installed in a device including a different processor, and cause the processor to execute the program, thereby causing the device to perform the above processing.

### Further Information about Technical Background to this Application

The disclosures of the following patent application including specification, drawings and claims are incorporated herein by reference in their entirety: Japanese Patent Application No. 2023-209681 filed on Dec. 12, 2023.

### INDUSTRIAL APPLICABILITY

The present disclosure is useful in a system or the like for addressing vulnerability of software provided to vehicles.

What is claimed is:

1. An analysis support system that supports analysis for addressing vulnerability of software provided to vehicles, the analysis support system comprising:
an obtainer that obtains vehicle type information on each of a plurality of vehicle types of the vehicles provided with the software having vulnerability; and
a determiner that performs a first determination to classify the plurality of vehicle types into two or more groups for the analysis, based on the vehicle type information obtained for each of the plurality of vehicle types.

2. The analysis support system according to claim 1, wherein
the vehicle type information includes information indicating a vehicle configuration of a corresponding one of the plurality of vehicle types, and
the determiner performs the first determination based on a level of matching of the vehicle configuration between the plurality of vehicle types.

3. The analysis support system according to claim 2, wherein
the information indicating the vehicle configuration includes information on one or more devices disposed on an attack path predicted based on the vulnerability, and
the determiner performs the first determination based on a level of matching of the one or more devices between the plurality of vehicle types.

4. The analysis support system according to claim 3, wherein
the information indicating the vehicle configuration includes information on one or more predetermined points disposed on the attack path predicted based on the vulnerability, and
the determiner performs the first determination based on a level of matching of the one or more predetermined points between the plurality of vehicle types.

5. The analysis support system according to claim 4, wherein
the one or more the predetermined points include at least one of an entry point, a device including a security countermeasure function, or a target asset to be attacked.

6. The analysis support system according to claim 2, wherein
the vehicle type information includes information indicating whether or not a corresponding one of the plurality of vehicle types is a derivative vehicle type, and
the determiner performs the first determination based on whether or not each of the plurality of vehicle types is a derivative vehicle type.

7. The analysis support system according to claim 2, wherein
a device provided with the software having vulnerability includes a plurality of functions, and
the determiner performs the first determination based on a similarity of an available or unavailable setting for each of the plurality of functions of the device between the plurality of vehicle types.

8. The analysis support system according to claim 1, wherein
a plurality of determination conditions are set for the first determination,
the obtainer obtains a first vulnerability analysis result of analyzing vulnerability of each of the plurality of vehicle types provided with the software having vulnerability, and
the determiner performs the first determination under a determination condition or a combination of two or more determination conditions identified from the plurality of determination conditions based on at least one of the vehicle type information or the first vulnerability analysis result.

9. The analysis support system according to claim 1, wherein
the obtainer further obtains, for each of the plurality of vehicle types, information indicating an Over The Air (OTA) compatibility state of at least one of the vehicle type or a device provided with the software having vulnerability, and
the determiner performs a second determination for classifying two or more vehicle types classified in each of the two or more groups into two or more sub-groups, based on the information indicating the OTA compatibility state.

10. The analysis support system according to claim 9, wherein
the determiner determines, for each of the plurality of vehicle types, whether or not the vehicle type is compatible with OTA, based on the information indicating the OTA compatibility state, and
when the vehicle type is determined to be compatible with OTA, the determiner further determines whether or not the device provided with the software having vulnerability is compatible with OTA.

11. The analysis support system according to claim 1, wherein
the obtainer obtains, for each of the two or more groups classified, a second vulnerability analysis result regarding each of one or more vehicle types classified into the group, under assumption that a countermeasure for vulnerability of the software provided to the vehicle type has been performed, and
the determiner excludes, from the group, a vehicle type for which a risk under the assumption is not lower than the risk before the countermeasure is performed.

12. The analysis support system according to claim 1, further comprising:
a notifier that performs notification of completion of the first determination performed by the determiner.

13. The analysis support system according to claim 1, further comprising:
a display outputter that causes a display device to display a determination result of the determiner.

14. An analysis support method of supporting analysis for addressing vulnerability of software provided to vehicles, the analysis support method comprising:
obtaining vehicle type information on each of a plurality of vehicle types of the vehicles provided with the software having vulnerability; and
performing a first determination to classify the plurality of vehicle types into two or more groups for the analysis, based on the vehicle type information obtained for each of the plurality of vehicle types.

15. A non-transitory computer-readable recording medium for use in a computer, the recording medium having recorded thereon a computer program for causing the computer to perform the analysis support method according to claim 14.
